(19) United States
(12) Patent Application Publication
(10) Pub. No.: US 2005/0012606 A1
(43) Pub. Date: Jan. 20, 2005

(54) Unfastened seat belt warning apparatus and method thereof

(76) Inventor: Jeong-Kee Lee, Hwascong-city (KR)

Correspondence Address: MORGAN, LEWIS & BOCKIUS LLP (SF), 2 PALO ALTO SQUARE, PALO ALTO, CA, 94306, US

(21) Appl. No.: 10/887,722

(22) Filed: Jul. 9, 2004

(30) Foreign Application Priority Data
Jul. 9, 2003 (KR) 10-2003-0046471

(51) Int. Cl. B60Q 1/00

(52) U.S. Cl. 340/457.1

(57) ABSTRACT

The present invention relates to an unfastened seat belt warning apparatus and method for a vehicle and is adapted to illuminate or flicker a warning light and generate a warning alarm, once the engine is running, on the basis of the fastened and unfastened state of the seat belt, the vehicle speed state and the driving time state, thus alerting the driver of the unfastened state of the seat belt in a visible and audible manner so that the driver may fasten the seat belt before a vehicle collision, a rollover, or other dangerous event.

### CROSS-REFERENCE TO RELATED APPLICATIONS

This application claims priority of Korean Application No. 10-2003-0046471, filed on Jul. 9, 2003, the disclosure of which is incorporated fully herein by reference.

### FIELD OF THE INVENTION

The present invention relates to an unfastened seat belt warning apparatus and a method incorporated in a vehicle. More particularly, the present invention is adapted to illuminate or flicker a warning light and/or emit a warning alarm for a certain period of time when the ignition key is turned on and the vehicle is driven at a speed exceeding a predetermined speed while the driver's seat belt is unfastened, thereby reminding the driver of his or her seat belt's unfastened state and protecting the driver in the event of a vehicle collision or the like by alerting the driver to fasten the seat belt in advance.

### BACKGROUND OF THE INVENTION

As is well known, seat belts are equipped in vehicles to protect vehicle occupants in the event of an accident such as a vehicle collision or a rollover. Most countries mandate that occupants wear a seat belt while driving, and almost all vehicles are provided with unfastened seat belt warning apparatus to avoid driving in the state of an unfastened seat belt. However, in a conventional unfastened seat belt warning apparatus, once the ignition key is turned on, a warning alarm or a warning light is activated for a predetermined period of time regardless of whether the vehicle stops or moves. Thus, the warning alarm or warning light of the conventional system notifies the driver of the non-engaged state of the seat belt only for a prescribed time period regardless of the vehicle speed. This tends to cause the driver to overlook the potential hazardous state of driving at a high speed without buckling the seat belt.

### SUMMARY OF THE INVENTION

According to the invention, there is provided an unfastened seat belt warning apparatus and method for a vehicle adapted to activate a warning light and/or a warning alarm in based upon the state of engine ignition and the vehicle speed to inform a driver of the unfastened state of his or her seat belt in a visual and/or audible manner.

In the preferred embodiment of the present invention, the unfastened seat belt warning apparatus comprises an engine state detecting means for detecting whether the engine ignition key is turned on. A seat belt state detecting means detects whether the driver's seat belt is fastened. A vehicle speed detecting means detects the speed of the vehicle. Finally, a means illuminates or flickers a warning light and/or generates a warning alarm on the basis of signals detected from the above detecting means.

The unfastened seat belt warning method comprises the steps of detecting whether the engine ignition key is turned on; if the ignition key is turned on, then detecting whether the driver is wearing the seat belt and determining the vehicle speed and driving time; and illuminating or flickering a warning light and/or generating a warning alarm based on the states of the fastened and unfastened seat belt, the vehicle speed, and the driving time. Accordingly, once the driver turns on the engine ignition key without fastening the seat belt, the warning light illuminates or flickers according to the vehicle speed and the vehicle moving state, and a warning alarm is generated if the vehicle speed exceeds a predetermined speed, thus enabling the driver to visibly and audibly recognize the unfastened state of the seat belt and protecting the driver in a vehicle collision or a rollover by alerting the driver to fasten the seat belt in advance.

### BRIEF DESCRIPTION OF THE DRAWINGS

For a better understanding of the nature and objects of the present invention, reference should be made to the following detailed description with the accompanying drawings, in which:

FIG. 1 is a block diagram of an unfastened seat belt warning apparatus for a vehicle according to an embodiment of the present invention;

FIG. 2 is a flowchart representing an unfastened seat belt warning method for a vehicle according to an embodiment of the present invention; and

FIG. 3 is a timing diagram for describing an unfastened seat belt warning apparatus and method for a vehicle according to an embodiment of the present invention.

### DETAILED DESCRIPTION OF THE PREFERRED EMBODIMENTS

The preferred embodiment of the present invention will now be described in detail with reference to the attached drawings.

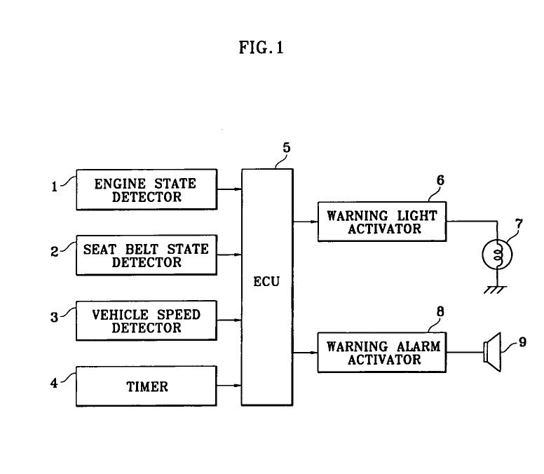

Referring to FIG. 1, the unfastened seat belt warning apparatus for a vehicle according to an embodiment of the present invention comprises an engine state detector 1 for detecting whether the engine ignition key is turned on. A seat belt state detector 2 detects whether a driver's seat belt is fastened. A vehicle speed detector 3 detects the speed of the vehicle. A timer 4 clocks the points in time in which each detector is checked to control the seat belt warning apparatus. An Electronic Control Unit (ECU) 5 receives signals from the detectors and timer, carries out a preset control program, and then generates an signal corresponding to the signals it received from the detectors and timer. A warning light activator 6 turns on, turns off, or flickers a warning light 7 when it receives the signal from the ECU 5. A warning alarm activator 8 controls the operation of a warning alarm generator 9 when it receives a signal from the ECU 5.

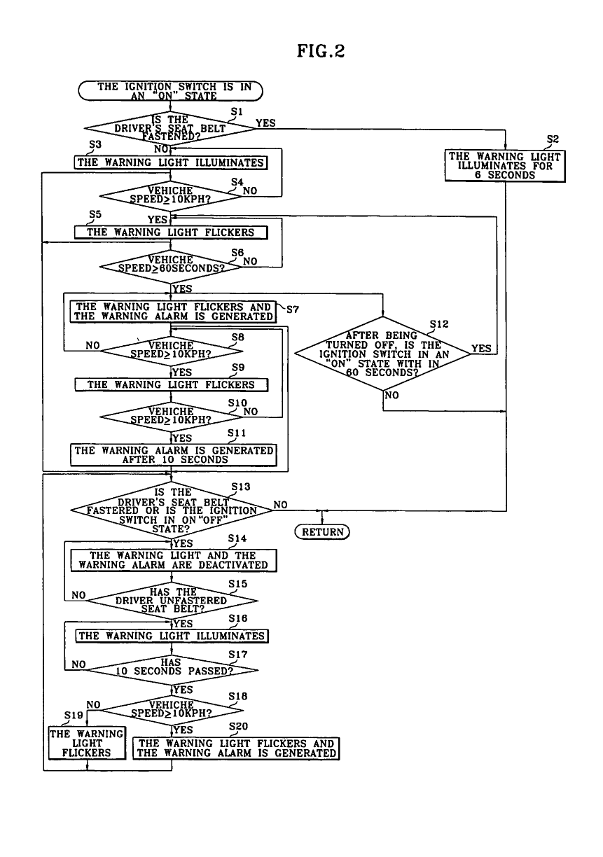

With reference to FIG. 2, the unfastened seat belt warning method for a vehicle according to the embodiment of the present invention comprises the following steps. If the ECU 5 determines from the signals received from the engine state detector 1 and seat belt state detector 2 that the driver turned on the ignition key of the engine after fastening the seat belt, the ECU 5 sends a signal to the warning light activator 6 to illuminate the warning light 7 for a first predetermined time period (e.g., 6 seconds) (S1 and S2), after which the warning light 7 is turned off. If the driver's seat belt is not fastened when the engine ignition key is turned on, then the ECU 5 sends a signal to the warning light activator 6 to illuminate the warning light 7 without any time limit (S1 and S3).

Then, if, on receiving a signal from the vehicle speed detector 3, the ECU 5 determines that the speed of the vehicle is less than a predetermined speed (e.g., 10 KPH), the ECU 5 maintains the illuminated state of the warning light 7 by controlling the warning light activator 6. However, if the vehicle speed exceeds the predetermined speed, the ECU 5 controls the warning light activator 6 to flicker the warning light 7 (S4 and S5).

If the warning light 7 maintains the flickering state for more than or equal to a second predetermined time period (e.g., 6 seconds) due to the vehicle speed exceeding the predetermined speed, then the ECU 5 controls the warning alarm activator 8 to generate a warning alarm via the warning alarm generator 9 (S6 and S7).

If the vehicle decelerates below the predetermined speed (e.g., 10 KPH) while the warning light 7 flickers and the warning alarm is emitted, then only the warning light 7 remains flickering and the warning alarm is turned off. However, if the vehicle then accelerates to and maintains a speed above the predetermined speed after a third predetermined time period (e.g., 10 seconds) elapses, then the warning alarm is emitted again (S8, S9, S10, and S11).

However, once the driver fastens the seat belt upon recognizing the illumination or flickering of the warning light 7 or the sound of the warning alarm, the ECU 5 controls the warning light activator 6 to deactivate the warning light 7 and controls the warning alarm activator 8 and the warning alarm generator 9 to deactivate the warning alarm (S13 and S14).

After the warning light 7 and/or warning alarm is deactivated by fastening the seat belt, if the driver unfastens the seat belt again, the ECU 5 turns on the warning light 7 (S15, S16). Furthermore, if the warning light 7 is in an “ON” state for a fourth predetermined time period (e.g., 10 seconds) due to the unfastend state of the seat belt and if the vehicle speed exceeds a predetermined speed, then the warning light 7 flickers and the warning alarm is emitted. However, if the vehicle speed is less than the predetermined speed, only the warning light 7 flickers (S17, 18, 19 and 20).

If the ignition key is turned off and then turned on within a fifth predetermined time period (e.g., 60 seconds) while the warning light 7 flickers and the warning alarm is emitted, the unfastened seat belt warning method restarts from flickering the warning light 7 of step 5 (S12).

The flickering of the warning light 7 is maintained until the driver fastens the seat belt, but the warning alarm is generated for a maximum 97 seconds.

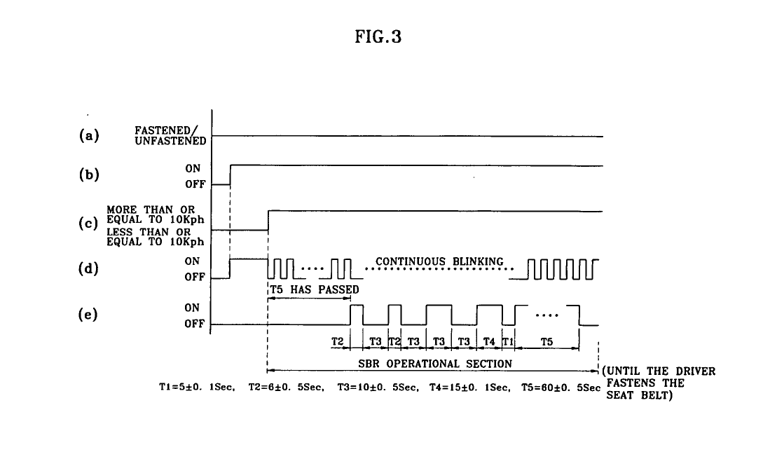

The operation effect of the unfastened seat belt warning apparatus and method according to the embodiment of the present invention will now be described in detail in reference to FIG. 3.

In FIG. 3, section (a) represents the state of the seat belt of the vehicle, section (b) represents the engine state (state of the ignition key), section (c) represents the state of the vehicle speed, section (d) represents the state of the warning light, and section (e) represents the operational state of the warning alarm generator. The ECU 5 receives the output signals from the engine state detector 1, seat belt state detector 2, and the vehicle speed detector 3. Simultaneously, the ECU 5 receives the time information provided from the timer 4 for determining whether to illuminate or flicker the warning light and whether to generate the warning alarm on the basis of the predetermined control program according to the ignition state of the engine, fastened and unfastened state of the seat belt, the vehicle speed, and the like. That is, when the engine ignition is initially turned on while a driver is fastened with the seat belt, the warning light is activated and then deactivated within, for example, 6 seconds. On the other hand, if the engine ignition is turned on while the driver's seat belt is unfastened and the vehicle moves at a speed, for example, exceeding 10 KPH, then the warning light 7 flickers to visibly notify the driver of the unfastened state of his or her seat belt. If, in spite of the flickering of the warning light 7, the driver drives the vehicle without fastening the seat belt for a period of time (e.g., over 60 seconds) at a speed exceeding the prescribed value, then the ECU 5 activates the warning alarm generator 9 via the warning alarm activator 8 to generate an audible warning alarm for approximately 97 seconds in maximum.

While the warning light is flickering or illuminated or the warning alarm is generated, if the vehicle speed decelerates below the predetermined speed, the flickering of the warning light is maintained but the warning alarm stops. Nevertheless, if the vehicle speed exceeds the predetermined speed, then the warning alarm is re-generated after a certain period of time (e.g., 10 seconds). On the other hand, if the driver is aware of the warning signals and fastens the seat belt while driving at a speed exceeding the predetermined value, the warning light 7 and the warning alarm generator 9 are deactivated by the ECU 5. Moreover, if the driver unfastens the seat belt again, the warning light 7 illuminates immediately. After the warning light and/or the warning alarm is deactivated by fastening the seat belt, and the warning light is turned on again by subsequently unfastening the seat belt, and a certain period of time passes (e.g., 10 seconds), the warning light either starts to flicker by itself or both the warning light and warning alarm are activated depending on the vehicle speed. That is, if the vehicle speed exceeds the predetermined value, the warning light flickers and the warning alarm is generated. And if the vehicle speed is less than the predetermined value, only the warning light flickers.

Provided that the driver fastens the seat belt or the engine is turned off while the warning light and/or the warning alarm is activated, the warning signals are deactivated. However, if the vehicle door is opened, an opened door warning device is activated in conjunction with the activation of the unfastened seat belt warning apparatus of the present invention (that is, the warning alarm is emitted by the opened door warning device and the warning light is activated by the unfastened seat belt warning apparatus).

If the operation of the opened door warning device is released and the warning light is turned on due to the unfastened seat belt state, the illumination of the warning light is maintained (that is, the vehicle is moving at a speed below the predetermined speed). However, if the vehicle moves at a speed exceeding the predetermined value, then the warning light and warning alarm operate according to each condition described above. On the other hand, if the warning light maintains the flickering due to the vehicle speed exceeding the predetermined value, the warning alarm is emitted after about 10 seconds.

After driving at a speed exceeding a predetermined speed and turning off the ignition key, if the driver turns on the ignition key again within 60 seconds, the operation is re-started from the stage of flickering the warning light 7. Nonetheless, if the engine is re-started after 60 seconds has passed, the operation starts from the initial step.

As apparent from the foregoing, the present invention has the advantage of, when the driver unfastens his or her seat belt while the engine is running, the warning light illuminates or flickers depending on the vehicle moving state and the vehicle speed, and the warning alarm is generated if the vehicle speed exceeds a predetermined speed, thus enabling the driver to be aware of the unfastened state of the seat belt through visible and audible means and protecting the driver from a potentially hazardous situation, such as a vehicle collision or a rollover, by alerting the driver to fasten his or her seat belt in advance.

1. An unfastened seat belt warning apparatus, the apparatus comprising:
engine state detecting means for detecting whether the engine ignition key is turned on;
seat belt state detecting means for detecting whether the driver's seat belt is fastened;
vehicle speed detecting means for detecting the speed of the vehicle; and
means for illuminating or flickering a warning light and generating a warning alarm on the basis of signals detected from said above detecting means.

2. An unfastened seat belt warning method, the method comprising the steps of:
detecting whether an engine ignition key is turned on;
detecting whether a seat belt is fastened;
detecting a vehicle speed and driving time, if the ignition key is turned on;
illuminating or flickering a warning light on the basis of the states of the fastened and unfastened seat belt, the vehicle speed, and the driving time; and
generating a warning alarm on the basis of the states of the fastened and unfastened seat belt, the vehicle speed, and the driving time.

3. The method in claim 2, wherein said illuminating or flickering occurs for a first predetermined time period if the engine ignition key is turned on after the seat belt is fastened.

4. The method in claim 2, wherein said illuminating occurs the engine ignition key is turned on, and the seat belt is unfastened, and the vehicle speed is less than a predetermined value.

5. The method in claim 2, wherein said flickering occurs if engine ignition key is turned on, the seat belt is unfastened, and the vehicle speed exceeds a predetermined value.

6. The method claim 5, wherein said generating occurs if said flickering is maintained for more than or equal to a second predetermined time period.

7. The method in claim 6, wherein if the vehicle speed decreases to below a predetermined speed while said flickering and generating occur, only said flickering is maintained, and if the vehicle speed subsequently exceeds the predetermined speed, then said generating occurs again after a third predetermined period of time passes.

8. The method in claim 2, wherein said illuminating or flickering and said generating ceases if the seat belt is fastened.

9. The method in claim 8, wherein said illuminating or flickering and said generating occurs again, subsequently to said illuminating or flickering and said generating ceased due to the seat belt becoming fastened, if the seat belt becomes unfastened.

10. The method in claim 9, wherein if, after said illuminating or flickering and said generating ceases due to the seat belt becoming fastened, said illuminating occurs again for more than a fourth predetermined time period due to the seat belt becoming unfastened, then said flickering and said generating occurs again according to the vehicle speed.

11. The method in claim 10, wherein if the vehicle speed exceeds the predetermined speed, then said flickering and said generating occurs, and if the vehicle speed is less than the predetermined speed, then only said flickering occurs.

12. An unfastened seat belt warning method, the method comprising the steps of:
detecting whether an engine ignition key is turned on;
detecting whether a seat belt is fastened;
detecting a vehicle speed and driving time, if the ignition key is turned on; and
alerting, by visual and audible means, the fastened or unfastened state of the seat belt, the vehicle speed, and the driving time
